(19) United States
(12) Patent Application Publication
(10) Pub. No.: US 2009/0072435 A1
(43) Pub. Date: Mar. 19, 2009

(54) PASSIVE DEVICE POLYMER CARRIER TAPE AND PROCESS THEREOF

(76) Inventors: Chi-Yuan HUANG, Taipei City (TW); Chia-I Liu, Taipei City (TW); Po-Ching Huang, Jhonghe City (TW)

Correspondence Address: SINORICA, LLC, 528 FALLSGROVE DRIVE, ROCKVILLE, MD, 20850, US

(21) Appl. No.: 11/855,874

(22) Filed: Sep. 14, 2007

(51) Int. Cl. C08L 31/04; B29C 47/60; C08K 3/10

(52) U.S. Cl. 264/211.23; 524/427

(57) ABSTRACT

A polymer carrier tape for placement of a passive device includes polymer of 10˜80% by weight of polyolefin (e.g., PE, PP), polymer of polyolefin grafted with acid anhydride or polymer of cross-linked polyolefin blended with calcium carbonate, ethylene-vinyl acetate (EVA), traces of anti-oxidant and 5˜30% anti-static agent by weight in a polymer compounding process to produce an admixture, the admixture is then molded into coiled carrier tape to replace conventional paper carrier tape.

### BACKGROUND OF THE INVENTION

(a) Field of the Invention

The present invention is related to a polymer carrier tape, and more particularly, to a polymer carrier tape for placement of a passive device and a manufacturing process thereof.

(b) Description of the Prior Art

A carrier tape is applied in placement of electronic device in the packaging process of the electronic device, e.g., a passive device including resistance and capacitor so to protect the electronic device in transit by preventing it from being turned over or ejected.

Carrier tapes generally available in the market are usually made of conventional paper. The carrier tape made of paper provides features of permitting easy punch, deflectable, and high tensile strength to prevent easy breakage during the packaging process. However, the paper carrier tape is also found with flaws of having low strength and preventing easy reclaim for reuse. Furthermore, rising environmental awareness today has been causing the quotation of paper products to increasingly soar up resulting in higher production cost and difficult access to raw material.

### SUMMARY OF THE INVENTION

The primary purpose of the present invention is to provide a manufacturing process for a polymer carrier tape for a passive device to correct problems of insufficient strength and prevention of easy reclaim for reuse found with the conventional paper carrier tape. To achieve the purpose, polymer of 10˜80% by weight of polyolefin (e.g., PE, PP), polymer of polyolefin grafted with acid anhydride or polymer of cross-linked polyolefin blended with calcium carbonate, ethylene-vinyl acetate (EVA), traces of anti-oxidant and 5˜30% anti-static agent by weight in a polymer compounding process to produce an admixture, and the admixture is then molded into coiled carrier tape by means of a twin screw extruder.

In the polymer carrier tape manufactured using the process disclosed by the present invention, massive meshed structures appear in the admixture as the grains of calcium carbonate in the carrier tape hold open the ethylene-EVA to wrap up air for delivering good dimensional stability and tenacity to the admixture. Furthermore, addition of massive polyolefin polymer upgrades tensile strength of the admixture to prevent it from being deformed in the course of slitting. Addition of small amount of calcium carbonate helps increase the hardness and reduce the rebound of the admixture for the admixture to allow easy tear up as does with the paper.

Addition of traces of anti-oxidant in the carrier tape of the present invention prevents the massive oxidization generated in the course of compounding from damaging physical properties of the carrier tape; and the addition of 5˜30% anti-static agent delivers a surface resistance of 10⁹˜10¹¹Ω11 of the carrier tape to achieve anti-static effects.

The polymer carrier tape of the present invention provides good deflection to prevent it from being easily break, allow repeated use, and good waterproof effects due to polyolefin contained in the tape to provide hydrophobic property for the carrier tape. The addition of calcium carbonate increases hardness of the carrier tape thus to reduce rebound to prevent the electronic device from loosening up in the tape winding process.

Accordingly, the present invention provides the advantage including but not limited to the followings:
1. Excellent deflection to allow repeated recycle for reuse;
2. Good waterproof effects;
3. Giving anti-static effects;
4. Excellent dimensional stability and low rebound; and
5. High tensile strength and low deformation.

### BRIEF DESCRIPTION OF THE DRAWINGS

FIG. 1 is an SEM photo representing Unit 2-1 for observation of an internal structure of an admixture.

FIG. 2 is another SEM photo representing Unit 2-1 at higher multiple for observation of the internal structure the admixture.

FIG. 3 is an SEM photo representing Unit 2-6 for observation of an internal structure of an admixture.

FIG. 4 is another SEM photo representing Unit 2-6 at higher multiple for observation of the internal structure the admixture.

FIG. 5 is an SEM photo representing Unit 2-8 for observation of an internal structure of an admixture.

FIG. 6 is another SEM photo representing Unit 2-8 at higher multiple for observation of the internal structure the admixture.

FIG. 7 is an SEM photo representing Unit 2-14 for observation of an internal structure of an admixture.

FIG. 8 is another SEM photo representing Unit 2-14 at higher multiple for observation of the internal structure the admixture.

FIG. 9 is a flow path chart showing a manufacturing process of the present invention.

### DETAILED DESCRIPTION OF THE PREFERRED EMBODIMENTS

Referring to FIG. 9, a manufacturing process of a polymer carrier tape of the present invention for placement of a passive device is comprised of the following steps:

Step a: prepare 10˜80% polymer of polyolefin by weight and the polymer may be related to low density polyethylene (LDPE), high density polyethylene (HDPE), propylene (PP), linear low density polyethylene (LLDPE), or other polymer of polyolefin.

Step b: polymer compounding process, polymer of polyolefin, Polymer of polyolefin grafted with acid anhydride or polymer of cross-linked polyolefin blended with calcium carbonate, ethylene-vinyl acetate (EVA), anti-oxidant and anti-static agent are blended to go through the polymer compounding process to become an admixture; wherein, the amount of the anti-static agent is 5˜30% by weight, and traces of anti-oxidant, acid anhydrides, and initiators are added with the remaining containments comprised of calcium carbonate and EVA.

Step c: Molding, the admixture is molded into a coiled carrier tape in a thickness of 0.4˜0.6 mm by means of a twin screw extruder.

Massive meshed structures appearing in the admixture when calcium carbonate grains contained in the polymer carrier tape of the present invention hold open the EVA to wrap up air give good dimensional stability and tenacity to the admixture. Addition of massive polyolefin polymer upgrades tensile strength of the admixture to prevent it from being vulnerable to deformation in the slitting process. Addition of small amount of calcium carbonate increases hardness of the admixture to reduce rebound thus to give easy tear property for the polymer carrier tape as does with the paper carrier tape.

Furthermore, addition of traces of anti-oxidant helps prevent physical properties of the carrier tape from being damaged by massive oxidization generated in the compounding process. Addition of 5˜30% anti-static agent gives a surface resistance of 10⁹˜10¹¹Ω for the carrier tape to achieve anti-static effects.

In an experiment to be described below, calcium carbonate (CaCO₃) respectively treated with polyolefin polymer and EVA, and coupling reagent is used in the compounding process for manufacturing the polymer carrier tape to compare changes in mechanical properties of the admixture.

To the Ethylene-Vinyl Acetate (EVA), its crystallization, hardness, rigidity, and heat deflection temperature tend to gradually step down as containment of Vinyl Acetate (VA) increases; however, its gloss, transparency, impact withstanding, tenacity, stress cracking withstanding, solubility in solvent, thermal shrinkage, and thermic welding are increased in various extents. Use of EVA containing 15˜40% VA gives proper tenacity and elasticity to make it a perfect material for making into sole, sealing sticks, cable products, and foamed plastic products.

In the experiment, massive polyolefin polymer are used to respectively be mixed with EVA, and CaCO₃ pretreated with coupling reagent in the compounding process to make into an admixture similar to a paper tape; and the admixture indicates high strength, flexibility, and low rebound while changes in mechanical properties of the admixture under various process conditions are compared.

The experiment executes a primary compounding process using CaCO₃/EVA/Polyolefin polymer in different ratios to manufacture the admixture having a white appearance, flexibility, and low rebound that are similar to a paper tape; the admixture is modified to provide tensile strength required in slitting process and the ability to be free of deformation in a temperature higher than the ambient temperature in transit; and allow it to be continuous extruded with a single or twin screw extruder for realizing the purpose of merchandized.

Results of Experiment: different mixing ratios of CaCO3/EVA/Polyolefin polymer are given different processes for comparison of impacts upon physical properties of the admixture in the hope to arrive at the preset targets.

Formula and compounding conditions are tabulated as follows:

TABLE 1
Changes of Tensile Strength & Elongation of
Admixture by Ratio & Method of Process

| Unit | 2-1 | 2-6 | 2-8 | 2-14 |
|---|---|---|---|---|
| CaCO3 (g) | 12 | 12 | 12 | 12 |
| EVA (g) | 24 | 10 | 10 | 5 |
| Polyolefin | 24 | 38 | 36 | 0 |
| Polymer (A) (g) | | (Cross-link) | | |
| Polyolefin | 0 | 0 | 0 | 43 |
| Polymer (B) (g) | | | | |
| Tensile | 5.79 | 6.18 | 5.82 | 19.97 |
| Strength (MPa) | | | | |
| Elongation (%) | 784.60 | 803.93 | 359.53 | 83.22 |

(a) In the experiment, 2 phr anti-oxidant is added to each unit.

Referring to Table 1, CaCO₃ and EVA are respectively added to the polyolefin polymer in the compounding process for the manufacturing of a polymer carrier tape. The addition of CaCO₃ helps increase the hardness of the admixture and reduce consumption of polymer for cost reduction.

As told from Table 1, (1) addition of small amount of initiators (e.g., DCP, BPO, and AIBN) initiates minor cross-link in the polyolefin polymer before the polyolefin polymer is smashed to compound with EVA and CaCO₃ and a finished product of the admixture is observed with significant increase of tensile strength. (2) in another process, an objective of making the admixture with high strength and low deflection is achieved by adding small amount of polyolefin polymer grafted with acid anhydride; and (3) after use of polyolefin polymer to mix with EVA and CaCO₃ to be heated for compounding in another process yet, the objective of high strength is achieved the same for the tensile strength of the admixture.

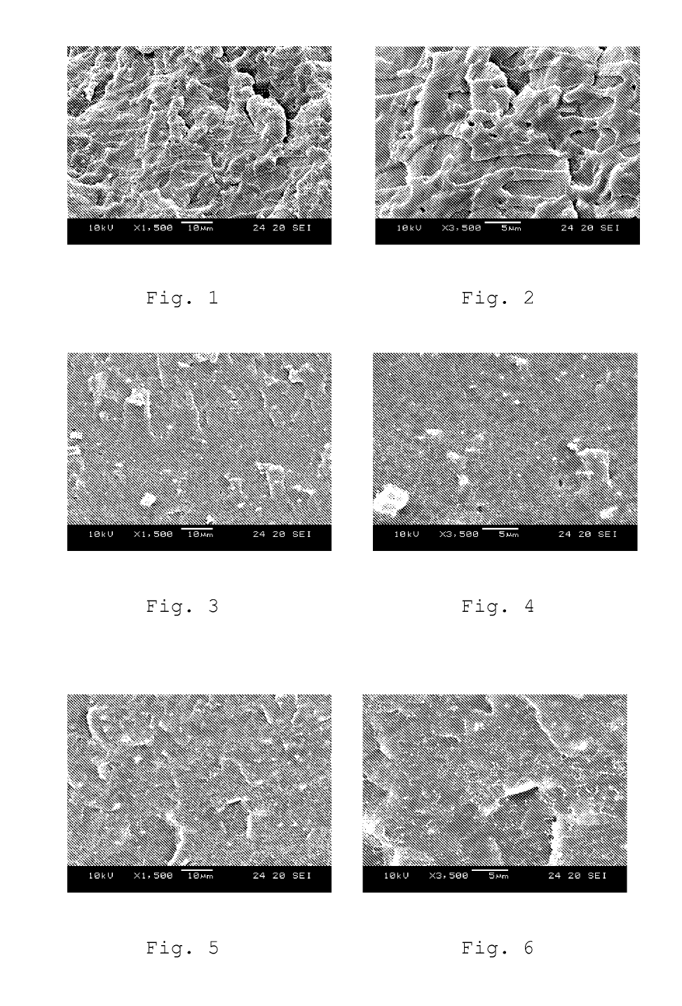

In the experiment, formula comprised of CaCO₃/EVA/polyolefin polymer is used for manufacturing a polymer carrier tape. As illustrated in FIGS. 1 and 2 for SEM photos to observe internal structure of the admixture, simultaneous addition of polyolefin polymer, EVA and CaCO₃ to be heated and compounded, EVA indicates in the compounding process stripes scattering around in a basic material of the polyolefin polymer when subject to shear in the compounding process to pay excellent elongation for the admixture.

As observed from FIGS. 3 and 4, addition of small amount of initiators causes formation of minor cross-link in the polyolefin polymer before being compounded with EVA and CaCO₃, and significant cross-link structure appears on a base of the resultant admixture to provide the admixture better tensile strength while distribution therein of small amount of CaCO₃ grains helps the admixture increase its hardness.

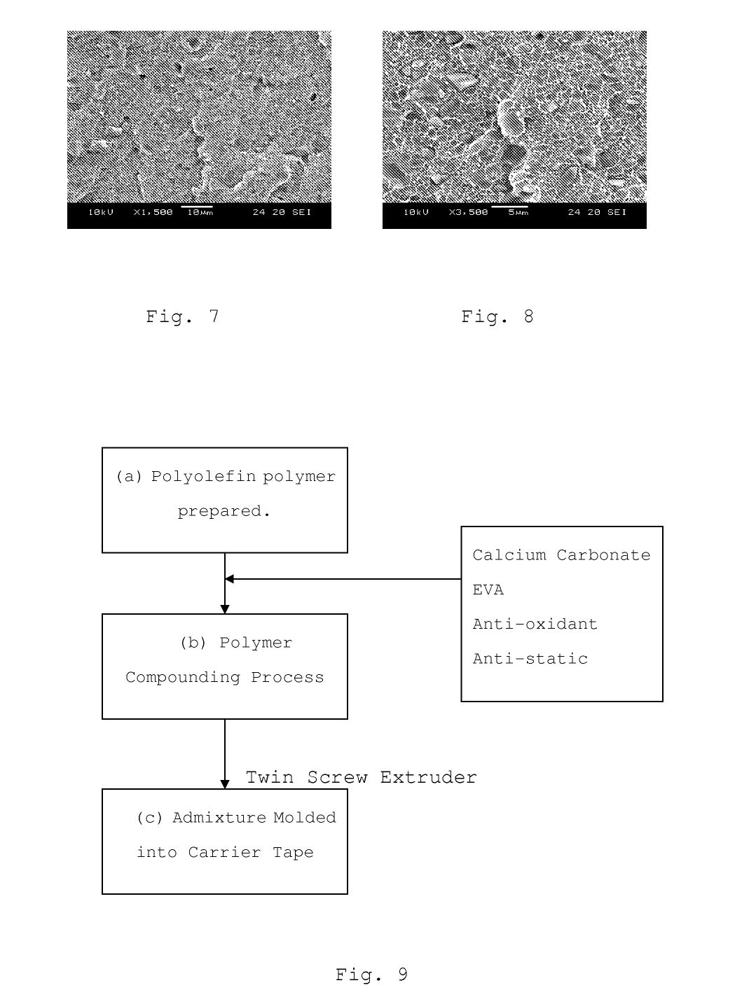

Minor cross-link structure can be observed in FIGS. 5 and 6 when small amount of polyolefin polymer grafted with acid anhydride is added to the admixture of CaCO₃/EVA/polyolefin polymer because that the acid anhydride in the heated compounding process could easily develop ring opening to form cross link by bonding to acid anhydride surrounding it; and more acid anhydrides are involved in reaction as amount of addition of polyolefin polymer grafted with acid anhydride increases. Therefore, massive meshed cross-link structures can be observed in the admixture and those structures help increase tensile strength of the admixture.

In another process yet substituted with other type of polyolefin polymer to be headed and compounded with EVA and CaCO₃, large area of meshed structures held open by CaCO₃ grains can be observed from SEM photos as illustrated in FIGS. 7 and 8 to provide good dimensional stability for the admixture; and the tensile strength of the admixture is significantly increased to such extent as desired when addition of polyolefin polymer increases.

I claim:

1. A process for manufacturing a polymer carrier tape for placement of a passive device comprising the following steps:
Step a: prepare 10˜80% polymer of polyolefin by weight;
Step b: polymer compounding process, wherein the polyolefin polymer, calcium carbonate (CaCO₃), ethylene-vinyl acetate (EVA), anti-oxidant, and anti-static agent are blended to go through the polymer compounding process to become an admixture; wherein, the amount of the anti-static agent is 5˜30% by weight, and traces of anti-oxidant, acid anhydrides, and remaining containments comprised of calcium carbonate and EVA.
Step c: Molding, the admixture is molded into a coiled carrier tape.

2. The manufacturing process of the carrier tape for a passive device as claimed in claim 1, wherein the polyolefin polymer is selected from LDPE, HDPE, LLDPE and PP.

3. The manufacturing process of the carrier tape for a passive device as claimed in claim 1, wherein the molded carrier tape is in a thickness of 0.4˜0.6 mm.

4. The manufacturing process of the carrier tape for a passive device as claimed in claim 1, wherein the admixture resulted from the polymer compounding process is extruded using a twin screw extruder into a carrier tape.

5. A polymer carrier tape for a passive tape is manufactured using 10˜80$ polyolefin polymer by weight, calcium carbonate, ethylene vinyl acetate, traces of anti-oxidant, and 5˜30% anti-static agent by weight to produce an admixture through a polymer compounding process; and the admixture being molded into coiled carrier tape.

6. The polymer carrier tape for a passive device as claimed in claim 5, wherein massive meshed structures appear in the admixture as the grains of calcium carbonate in the carrier tape hold open the ethylene-EVA to wrap up air for delivering good dimensional stability and tenacity to the admixture. Furthermore, addition of massive polyolefin polymer upgrades tensile strength of the admixture to prevent it from being deformed in the course of slitting. Addition of small amount of calcium carbonate helps increase the hardness and reduce the rebound of the admixture for the admixture to allow easy tear up as does with the paper.

7. The polymer carrier tape for a passive device as claimed in claim 5, wherein addition of traces of anti-oxidant helps prevent physical properties of the carrier tape from being damaged by massive oxidization generated in the compounding process.

8. The polymer carrier tape for a passive device as claimed in claim 5, wherein Addition of 5˜30% anti-static agent gives a surface resistance of 10⁹˜10¹¹Ω to achieve anti-static effects.
